(19) United States
(12) Patent Application Publication
(10) Pub. No.: US 2025/0050568 A1
(43) Pub. Date: Feb. 13, 2025

(54) A 3D LOOP ARTICLE AND METHOD FOR PREPARING THE SAME

(71) Applicant: Dow Global Technologies LLC, Midland, MI (US)

(72) Inventors: Xilun Weng, Shanghai (CN); Ming Ming, Shanghai (CN); Zheng Zhang, Shanghai (CN); Xudong Huang, Shanghai (CN); Xiaobing Yun, Shanghai (CN); Yabin Sun, Shanghai (CN); Tao Wang, Shanghai (CN)

(21) Appl. No.: 18/721,693

(22) PCT Filed: Feb. 9, 2022
(86) PCT No.: PCT/CN2022/075601

§ 371 Date: Jun. 19, 2024

(51) Int. Cl. B29C 48/00; B29C 48/91; B29L 31/58

(52) U.S. Cl. CPC B29C 48/022; B29C 48/91; B29K 2023/06; B29K 2995/0012; B29K 2995/0063; B29L 2031/58

(57) ABSTRACT

A 3D loop article made of a material comprising polyethylene, ethylene/α-olefin copolymer, or a blend of polyethylene and ethylene/α-olefin copolymer, wherein the material has a low-perfection crystal melting enthalpy, calculated within a temperature range of 15-80° C., of less than or equal to 30 J/g.

### FIELD OF THE INVENTION

The present disclosure relates to a 3D loop article and a method for preparing the same.

### INTRODUCTION

Polyethylene (PE) or polyolefin elastomer (POE) has been proved successful in 3D Loop (3DL) applications such as mattress and pillow application. Compared to polyurethane (PU) foam, polyethylene (PE) or polyolefin elastomer (POE) 3D loop cushion has excellent breathability, easy clean performance, and it is also recyclable by nature. Based on the advantageous performance, 3D loop cushion has great potential for vehicle seat application. However, there remains key challenge of heat resistance performance.

However, current POE or PE made 3D loop cushion formulation has poor compression residual strain (>45%) at 70° C. with 50% testing compression strain (ASTM D3574, part D), which is far away from the incumbent PU foam performance.

Therefore, there is still a need for 3D loop article which has compression residual strain at 70° C. no greater 25%, preferably no greater than 20%.

### SUMMARY OF THE INVENTION

After persistent exploration, we have developed a POE/PE based 3D loop article with reduced melting enthalpy of low-perfection crystals (calculated within a temperature range of 15-80° C.) but still retaining good elasticity, which can meet the high temperature compression residual strain (70° C.) requirement of automotive seats (ASTM D3574, part D), i.e. no greater than 25%, and preferably no greater than 20%, more preferably no greater than 15%, or still more preferably no greater than 10%.

In a first aspect of the present disclosure, the present disclosure provides a 3D loop article made of a material comprising polyethylene, ethylene/α-olefin copolymer or a blend of polyethylene and ethylene/α-olefin copolymer, wherein the material has a low-perfection crystal melting enthalpy, calculated within a temperature range of 15-80° C., of less than or equal to 30 J/g.

Preferably, the polyethylene is selected from linear low density polyethylene (LLDPE), high density polyethylene (HDPE), low density polyethylene (LDPE), or a mixture thereof; the ethylene/α-olefin is selected from ethylene/α-olefin random copolymer, ethylene/α-olefin multi-block interpolymer, or a mixture thereof.

In a second aspect of the present disclosure, the present disclosure provides a method of producing the 3D loop article, comprising:
extruding the material comprising polyethylene, ethylene/α-olefin copolymer, or a blend of polyethylene and ethylene/α-olefin copolymer; and
performing a heat treatment at 70 to 90° C. for 0.5 hours to 5 days;
wherein the material after heat treatment has a low-perfection crystal melting enthalpy, calculated within a temperature range of 15-80° C., of less than or equal to 30 J/g.

Preferably, the polyethylene is selected from linear low density polyethylene (LLDPE), high density polyethylene (HDPE), low density polyethylene (LDPE), or a mixture thereof; the ethylene/α-olefin is selected from ethylene/α-olefin random copolymer, ethylene/α-olefin multi-block interpolymer, or a mixture thereof.

In a third aspect of the present disclosure, the present disclosure provides a 3D loop article made by the process of the present disclosure.

It is to be understood that both the foregoing general description and the following detailed description are exemplary and explanatory only and are not restrictive of the invention, as claimed.

### BRIEF DESCRIPTION OF THE DRAWINGS

FIG. 1 shows the 1st heating DSC curve and low-perfection crystal melting enthalpy area (shaded region) of the 3D loop sample of Example B-8.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

The numerical ranges disclosed herein include all values from, and including, the lower and upper value. For ranges containing explicit values (e.g., 1 or 2; or 3 to 5; or 6; or 7), any subrange between any two explicit values is included (e.g., 1 to 2; 2 to 6; 5 to 7; 3 to 7; 5 to 6; etc.). Unless stated to the contrary, implicit from the context, or customary in the art, all parts and percentages are based on weight and all test methods are current as of the filing date of this disclosure.

As disclosed herein, the term “composition”, “formulation” or “mixture” refers to a physical blend of different components, which is obtained by mixing simply different components by a physical means. The sum of the percentages by weight of each component in a composition is 100 wt %, based on the total weight of the composition.

As disclosed herein, “and/or” means “and, or as an alternative”. All ranges include endpoints unless otherwise indicated.

The term “polymer” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The crystal structure of polyolefins is an important factor that influences mechanical and heat resistance properties of the polyolefin materials. Enthalpy of melting is the energy required to melt a substance, which is a widely used parameter for crystalline and semi-crystalline materials. Differential Scanning Calorimeter (DSC) is a common thermodynamical tool for direct assessment of the heat energy uptake and release, which occurs in a sample during a regulated increase or decrease in temperature. Calorimetry is often applied to monitor phase transitions such as melting and crystallization. Melting enthalpy is determined from the total integrated heat flow within the thermogram peak, which indicates total heat energy uptake by the sample after suitable baseline correction affecting the transition. It is determined through shape analysis of an experimental graph of heat flow versus temperature.

Polymers are chemical compounds prepared by polymerizing monomers, whether of the same or a different type. The molecular length (or molecular weight) and molecular structure of individual polymer chains are not exactly the same, but have a distribution in length, weight, and structure. The distribution of co-monomer within a copolymer may not be perfectly random due to factors such as polymerization processing non-uniformity or catalyst co-monomer incorporation non-uniformity. As a result, the crystal structure of a semi-crystalline polymer is also a distribution of, for example, crystal size, crystal uniformity, and crystal melting temperature. As observed in DSC calorimetry curves, the crystal melting peaks of polymers are not as sharp as many single-crystal structured materials, but cover a temperature range. For example, a low-density polyethylene may have a peak melting temperature around 115° C., but still contain crystals that melt in the temperature range below 80° C. Herein, the melting peak area between 15 to 80° C. is used to define the melting temperature range of low-perfection crystals.

Usually, crystallites of varying size and melting points are formed upon cooling of a semi-crystalline polymer below the crystallization temperature. Smaller crystallites and crystallites with some defects can be formed that have lower melting temperatures, referred to here as “low-perfection crystallites”. Upon heating, the perfection of the crystallites can increase, increasing the melting temperature of those crystallites. The term “low-perfection crystal melting enthalpy” refers to an integral area calculated within a temperature range of 15-80° C. in the heating DSC curve of the 3D loop article described in the present disclosure.

### The Material for Making the 3D Loop Article

The material comprises at least 30% of polyethylene, ethylene/α-olefin copolymer, or a blend of polyethylene and ethylene/α-olefin copolymer; or at least 35% of polyethylene, ethylene/α-olefin copolymer, or a blend of polyethylene and ethylene/α-olefin copolymer; or at least 40% of polyethylene, ethylene/α-olefin copolymer, or a blend of polyethylene and ethylene/α-olefin copolymer; or at least 45% of polyethylene, ethylene/α-olefin copolymer, or a blend of polyethylene and ethylene/α-olefin copolymer; or at least 50% of polyethylene, ethylene/α-olefin copolymer, or a blend of polyethylene and ethylene/α-olefin copolymer; or at least 55% of polyethylene, ethylene/α-olefin copolymer, or a blend of polyethylene and ethylene/α-olefin copolymer; or at least 60% of polyethylene, ethylene/α-olefin copolymer, or a blend of polyethylene and ethylene/α-olefin copolymer; or at least 65% of polyethylene, ethylene/α-olefin copolymer, or a blend of polyethylene and ethylene/α-olefin copolymer; or at least 70% of polyethylene, ethylene/α-olefin copolymer, or a blend of polyethylene and ethylene/α-olefin copolymer; or at least 75% of polyethylene, ethylene/α-olefin copolymer, or a blend of polyethylene and ethylene/α-olefin copolymer; or at least 80% of polyethylene, ethylene/α-olefin copolymer, or a blend of polyethylene and ethylene/α-olefin copolymer; or at least 85% of polyethylene, ethylene/α-olefin copolymer, or a blend of polyethylene and ethylene/α-olefin copolymer; or at least 90% of polyethylene, ethylene/α-olefin copolymer, or a blend of polyethylene and ethylene/α-olefin copolymer; or at least 95% of polyethylene, ethylene/α-olefin copolymer, or a blend of polyethylene and ethylene/α-olefin copolymer; or at least 98% of polyethylene, ethylene/α-olefin copolymer, or a blend of polyethylene and ethylene/α-olefin copolymer; or at least 99% of polyethylene, ethylene/α-olefin copolymer, or a blend of polyethylene and ethylene/α-olefin copolymer; or 100% of polyethylene, ethylene/α-olefin copolymer, or a blend of polyethylene and ethylene/α-olefin copolymer, based on the total weight of the material.

The polyethylene is selected from linear low density polyethylene (LLDPE), high density polyethylene (HDPE), low density polyethylene (LDPE), or a mixture thereof. Suitable polyethylene can be ELIT™ 5815 Enhanced Polyethylene Resin or EXCEED™ 3518CB or a blend thereof

Preferably, the ethylene/α-olefin copolymer is selected from ethylene/α-olefin random copolymer, ethylene/α-olefin multi-block interpolymer, or a mixture thereof.

### A) Ethylene/α-Olefin Random Copolymer

An ethylene/α-olefin copolymer is an ethylene/propylene random copolymer or an ethylene/C4-C8 α-olefin random copolymer. In an embodiment, the ethylene/α-olefin copolymer is an ethylene/C4-C8 α-olefin copolymer. The ethylene/C4-C8 α-olefin copolymer is composed of, or otherwise consists of, ethylene and one copolymerizable C4-C8 α-olefin comonomer in polymerized form. The C4-C8 α-olefin comonomer may be selected from 1-butene, methyl-1-butene, 1-pentene, 1-hexene, 4-hexene, 5-methyl-1-hexene, 4-ethyl-1-hexene, or 1-octene.

The ethylene/α-olefin random copolymer has a density of between about 0.860 g/cc and about 0.965 g/cc, or between about 0.870 g/cc and about 0.925 g/cc, or between about 0.878 g/cc and about 0.920 g/cc, or between about 0.885 g/cc and 0.918 g/cc, or between about 0.890 g/cc and about 0.915 g/cc, or between about 0.895 g/cc and about 0.912 g/cc, or between about 0.890 g/cc and about 0.910 g/cc; the ethylene/α-olefin random copolymer for the inventive compositions described herein has a melt index (MI) at 190° C., 2.16 kg of no greater than about 40 g/10 min, or no greater than about 30 g/10 min, no greater than about 25 g/10 min, or no greater than about 22 g/10 min, or no greater than about 20 g/10 min, or no greater than about 18 g/10 min, or not greater than about 15 g/10 min. Alternatively, the ethylene/α-olefin random copolymer for the inventive compositions described herein has a MI from about 0.5 g/10 min to about 40 g/10 min, or from about 2.5 g/10 min to about 38 g/10 min, or from 3 g/10 min to about 30 g/10 min, or from about 3 g/10 min to about 25 g/10 min, or from about 3 g/10 min to about 20 g/10 min, or from about 5 g/10 min to about 18 g/10 min, or from about 10 g/10 min to about 15 g/10 min.

Suitable ethylene/α-olefin random copolymer can be ENGAGE™ POE from Dow, such as ENGAGE™ 8401 POE, ENGAGE™ 8402 POE, ENGAGE™ 8450 POE, or ENGAGE™ 8480 POE, or a blend thereof.

### B) Ethylene/α-Olefin Multi-Block Interpolymer (OBC)

The term “ethylene/α-olefin multi-block interpolymer”, also called “olefin block copolymer (OBC)” as used herein, refers to an interpolymer that includes ethylene and one or more copolymerizable α-olefin comonomers in polymerized form, characterized by multiple blocks or segments of two or more (preferably three or more) polymerized monomer units, the blocks or segments differing in chemical or physical properties. Specifically, this term refers to a polymer comprising two or more (preferably three or more) chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), region-regularity or region-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalyst systems. Non-limiting examples of the olefin block copolymers of the present disclosure, as well as the processes for preparing the same, are disclosed in U.S. Pat. Nos. 7,858,706 B2, 8,198,374 B2, 8,318,864 B2, 8,609,779 B2, 8,710,143 B2, 8,785,551 B2, and 9,243,090 B2, which are all incorporated herein by reference in their entirety.

Ethylene/α-olefin multi-block interpolymers are characterized by multiple blocks or segments of two or more polymerized monomer units, differing in chemical or physical properties.

In some embodiments, the multi-block copolymers can be represented by the following formula: (AB)n, where n is at least 1, preferably an integer greater than 1, such as 2, 3, 4, 5, 10, 15, 20, 30, 40, 50, 60, 70, 80, 90, 100, or higher. Here, “A” represents a hard block or segment, and “B” represents a soft block or segment. Preferably the A segments and the B segments are linked in a substantially linear fashion, as opposed to a substantially branched or substantially star-shaped fashion. In other embodiments, the A segments and the B segments are randomly distributed along the polymer chain. In other words, for example, the block copolymers usually do not have a structure as follows: AAA-AA-BBB-BB. In still other embodiments, the block copolymers do not usually have a third type of block or segment, which comprises different comonomer(s). In yet other embodiments, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

The olefin block copolymers, in general, are produced via a chain shuttling process, such as, for example, described in U.S. Pat. No. 7,858,706, which is herein incorporated by reference. Some chain shuttling agents and related information are listed in Col. 16, line 39, through Col. 19, line 44. Some catalysts are described in Col. 19, line 45, through Col. 46, line 19, and some co-catalysts in Col. 46, line 20, through Col. 51 line 28. Some process features are described in Col 51, line 29, through Col. 54, line 56. See also the following: U.S. Pat. Nos. 7,608,668; 7,893,166; and 7,947,793 as well as US Patent Publication 2010/0197880. See also U.S. Pat. No. 9,243,173.

Preferably, ethylene comprises the majority mole fraction of the whole ethylene/α-olefin multi-block copolymer, i.e., ethylene comprises at least 50 mol % of the whole ethylene/α-olefin multi-block copolymer. More preferably, ethylene comprises at least 60 mol %, at least 70 mol %, or at least 80 mol %, with the substantial remainder of the whole ethylene/α-olefin multi-block interpolymer comprising the C4-C8 α-olefin comonomer, preferably, the C4-C8 α-olefin comonomer may be selected from 1-butene, 1-hexene, and 1-octene. In an embodiment, the ethylene/α-olefin multi-block interpolymer contains from 50 mol %, or 60 mol %, or 65 mol % to 80 mol %, or 85 mol %, or 90 mol % ethylene. For many ethylene/octene multi-block interpolymers, the composition comprises an ethylene content greater than 80 mol % of the whole ethylene/octene multi-block interpolymer and an octene content of from 1 mol % to 20 mol %, or from 10 mol % to 20 mol % of the whole ethylene/octene multi-block interpolymer.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, or greater than 10 wt %, or greater than 15 wt %, based on the weight of the polymer. In an embodiment, the comonomer content in the soft segments is greater than 20 wt %, or greater than 25 wt %, or greater than 30 wt %, or greater than 35 wt %, or greater than 40 wt %, or greater than 45 wt %, or greater than 50 wt %, or greater than 60 wt % and can be up to 100 wt %.

The soft segments can be present in an ethylene/α-olefin multi-block interpolymer from 1 wt %, or 5 wt %, or 10 wt %, or 15 wt %, or 20 wt %, or 25 wt %, or 30 wt %, or 35 wt %, or 40 wt %, or 45 wt %, or 50 wt %, or 55 wt %, or 60 wt %, or 65 wt %, or 70 wt %, or 75 wt %, or 80 wt %, or 85 wt %, or 90 wt %, or 95 wt %, or 99 wt % of the total weight of the ethylene/α-olefin multi-block interpolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, the disclosure of which is incorporated by reference herein in its entirety. In particular, hard and soft segment weight percentages and comonomer content may be determined as described in column 57 to column 63 of U.S. Pat. No. 7,608,668.

In an embodiment, the ethylene/α-olefin multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/α-olefin multi-block copolymer possesses Mw/Mn from 1.0 to 3.5, or from 1.3 to 3, or from 1.4 to 2.5, or from 1.4 to 2.

Non-limiting examples of suitable ethylene/α-olefin multi-block copolymer are disclosed in U.S. Pat. No. 7,608,668, the entire content of which is incorporated by reference herein.

In an embodiment, the ethylene/α-olefin multi-block copolymer has hard segments and soft segments, is styrene-free, consists of only (i) ethylene and (ii) a C4-C8 α-olefin, and is defined as having a Mw/Mn from 1.7 to 3.5.

The ethylene/α-olefin multi-block interpolymer has a density of between about 0.860 g/cc and about 0.900 g/cc, or between about 0.870 g/cc and about 0.895 g/cc, or between about 0.880 g/cc and about 0.890 g/cc; the ethylene/α-olefin multi-block interpolymer described herein has a MI at 190° C., 2.16 kg of no greater than about 30 g/10 min, or no greater than about 25 g/10 min, or no greater than about 22 g/10 min, or no greater than about 20 g/10 min, or no greater than about 18 g/10 min, or not greater than about 15 g/10 min. Alternatively, the ethylene/α-olefin multi-block interpolymer for the inventive compositions described herein has a MI from about 0.5 g/10 min to about 30 g/10 min, 1 g/10 min to about 25 g/10 min, or from about 3 g/10 min to about 20 g/10 min, or from about 5 g/10 min to about 18 g/10 min, or from about 10 g/10 min to about 15 g/10 min.

Suitable ethylene/α-olefin multi-block interpolymer can be INFUSE™ OBC from Dow, such as INFUSE™ 9900 OBC.

### Material

The material for making the 3D loop article may comprise polyethylene, ethylene/α-olefin copolymer or a blend of polyethylene and ethylene/α-olefin copolymer. For examples, the material for making the 3D loop article may comprise one or more ethylene/α-olefin random copolymers, one or more ethylene/α-olefin multi-block interpolymers, one or more polyethylene, a blend of polyethylene(s) and ethylene/α-olefin multi-block interpolymers, a blend of polyethylene and ethylene/α-olefin random copolymer(s), a blend of ethylene/α-olefin random copolymer(s) and ethylene/α-olefin multi-block interpolymer(s), or a blend of polyethylene, ethylene/α-olefin random copolymer(s) and ethylene/α-olefin multi-block interpolymer(s). The constitution of the material for making the 3D loop article may vary, but it has an overall MI and density.

Preferably, the material of the 3D loop article of the present disclosure has a density of between about 0.880 g/cc and about 0.920 g/cc, preferably between about 0.885 g/cc and 0.918 g/cc, more preferably between about 0.890 g/cc and about 0.915 g/cc, even more preferably between about 0.895 g/cc and about 0.912 g/cc.

Preferably, the material of the 3D loop article of the present disclosure has a MI at 190° C., 2.16 kg of no greater than about 25 g/10 min, preferably no greater than about 22 g/10 min, more preferably no greater than about 20 g/10 min, more preferably no greater than about 18 g/10 min. Alternatively, the material of the present disclosure has a MI from about 1 g/10 min to about 25 g/10 min, preferably from about 3 g/10 min to about 20 g/10 min, more preferably from about 5 g/10 min to about 18 g/10 min, even more preferably from about 8 g/10 min to about 18 g/10 min.

The material comprising polyethylene, ethylene/α-olefin copolymer, or a blend of polyethylene and ethylene/α-olefin copolymer has a low-perfection crystal melting enthalpy, calculated within a temperature range of 15-80° C., of less than or equal to 30 J/g, or less than or equal to 29 J/g, or less than or equal to 25 J/g, or less than or equal to 22 J/g, or less than or equal to 21 J/g.

The material comprising polyethylene, ethylene/α-olefin copolymer, or a blend of polyethylene and ethylene/α-olefin copolymer and having a low-perfection crystal melting enthalpy, calculated within a temperature range of 15-80° C., of less than or equal to 30 J/g, or less than or equal to 29 J/g, or less than or equal to 25 J/g, or less than or equal to 22 J/g, or less than or equal to 21 J/g can be obtained via specifically designed heat treatment or other ways, e.g. production process optimization, to provide an optimized crystalline structure. For example, the heat treatment temperature can be 70 to 90° C., preferably 80 to 90° C. for 0.5 hrs to 5 days (or 4 hrs to 30 hrs, or 6 hrs to 24 hrs); preferably, 80° C. for 1 hrs to 2 days (or 4 hrs to 30 hrs, or 6 hrs to 24 hrs) or 90° C. for 4 hrs to 5 days (or 4 hrs to 2 days, or 6 hrs to 24 hrs).

Preferably, the material for making the 3D loop article is free of styrene polymer.

Moreover, the following can be added to the material: phthalate ester-based, trimellitate ester-based, aliphatic acid-based, epoxy-based, adipate ester-based, polyester-based, paraffin-based, naphthene-based, and aromatic-based plasticizers; known hindered phenol-based, sulfur-based, phosphorous-based, and amine-based antioxidants; hindered amine-based, triazole-based, benzophenone-based, benzoate-based, nickel-based, salicyl-based, and other light stabilizers; antistatic agents; antimicrobial agents; fluorescent whiteners; fillers; flame retardants; flame retardant auxiliaries; lubricants, and organic and inorganic pigments.

As an antioxidant, it is desirable to add at least one kind selected from a known phenol-based antioxidant, a phosphite-based antioxidant, a thioether-based antioxidant, a benzotriazole-based UV absorber, a triazine-based UV absorber, a benzophenone-based UV absorber, an N—H type hindered amine-based light stabilizer, and an N—CH3 type hindered amine-based light stabilizer.

Examples of the phenol-based antioxidant include 1,3,5-tris[[3,5-bis(1,1-dimethylethyl)-4-hydroxyphenyl]methyl]-1,3,5-triazine-2,4,6(1H,3H,5H)-trione, 1,1,3-tris(2-methyl-4-hydroxy-5-tert-butylphenyl)butane, 4,4′-butylidenebis(6-tert-butyl-m-cresol), 3-(3,5-di-tert-butyl-4-hydroxyphenyl)propionic acid stearyl, pentaerythritol tetrakis[3-(3,5-di-tert-butyl-4-hydroxyphenyl)propionate], Sumilizer AG 80, and 2,4,6-tris(3′,5′-di-tert-butyl-4′-hydroxybenzyl)mesitylene.

Examples of the phosphite-based antioxidant include 3,9-bis(octadecyloxy)-2,4,8,10-tetraoxa-3,9-diphosphaspiro[5.5]undecane, 3,9-bis(2,6-di-tert-butyl-4-methylphenoxy-2,4,8,10-tetraoxa-3,9-diphosphaspiro[5.5]u ndecane, 2,4,8,10-tetrakis(1,1-dimethylethyl)-6-[(2-ethylhexyl)oxy]-12H-dibenzo [d,g][1,3,2]dioxaphosphocin, tris(2,4-di-tert-butylphenyl)phosphite, tris(4-nonylphenyl)phosphite, 4,4′-isopropylidenediphenol C12-15 alcohol phosphite, diphenyl(2-ethylhexyl)phosphite, diphenyl isodecyl phosphite, triisodecyl phosphite, and triphenyl phosphite.

Examples of the thioether-based antioxidant include bis[3-(dodecylthio)propionate]2,2-bis[[3-(dodecylthio)-1-oxopropyloxy]methyl]-1,3-p ropanediyl and 3,3′-ditridecyl thiobispropionate.

A lubricant is selected from hydrocarbon-based waxes, higher alcohol-based waxes, amide-based waxes, ester-based waxes, metal soap, etc.

### Preparation Method

The method of producing the 3D loop article of the present disclosure comprises:
extruding the material comprising polyethylene, ethylene/α-olefin copolymer, or a blend of polyethylene and ethylene/α-olefin copolymer; and
performing a heat treatment at 70 to 90° C., preferably 80 to 90° C. for 0.5 hrs to 5 days (or 4 hrs to 30 hrs, or 6 hrs to 24 hrs); preferably, 80° C. for 1 hrs to 2 days (or 4 hrs to 30 hrs, or 6 hrs to 24 hrs) or 90° C. for 4 hrs to 5 days (or 4 hrs to 2 days, or 6 hrs to 24 hrs).
wherein the material after heat treatment has a low-perfection crystal melting enthalpy, calculated within a temperature range of 15-80° C., of less than or equal to 30 J/g.

### Extruding

The material comprising polyethylene, ethylene/α-olefin copolymer, or a blend of polyethylene and ethylene/α-olefin copolymer can be extruded to form the 3D loop article.

Preferably, the material to be extruded has a density of between about 0.880 g/cc and about 0.920 g/cc, preferably between about 0.885 g/cc and 0.918 g/cc, more preferably between about 0.890 g/cc and about 0.915 g/cc, even more preferably between about 0.895 g/cc and about 0.912 g/cc.

Preferably, the material to be extruded has a MI at 190° C., 2.16 kg of no greater than about 25 g/10 min, preferably no greater than about 22 g/10 min, more preferably no greater than about 20 g/10 min, more preferably no greater than about 18 g/10 min. Alternatively, the material to be extruded has a MI from about 1 g/10 min to about 25 g/10 min, preferably about 3 g/10 min to about 20 g/10 min, more preferably about 5 g/10 min to about 18 g/10 min, even more preferably about 8 g/10 min to about 18 g/10 min.

Preferably, the material to be extruded has a flexural modulus of at least 20 MPa, preferably at least 30 MPa, preferably at least 40 MPa, preferably at least 50 MPa, preferably at least 55 MPa, or even more preferably at least 60 MPa; but no greater than 150 MPa, preferably no greater than 140 MPa, preferably no greater than 130 MPa, preferably no greater than 120 MPa. The material to be extruded has a flexural modulus of from 20 MPa to 120 MPa.

### Heat Treatment

After extruding, a heat treatment can be done at 70 to 90° C., preferably 80 to 90° C. for 0.5 hrs to 5 days (or 4 hrs to 30 hrs, or 6 hrs to 24 hrs); preferably, 80° C. for 1 hrs to 2 days (or 4 hrs to 30 hrs, or 6 hrs to 24 hrs) or 90° C. for 4 hrs to 5 days (or 4 hrs to 2 days, or 6 hrs to 24 hrs).

### 3D Loop Article

The residual strain after compression set test was following the standard ASTM D3574 part D. The samples were compressed at 70° C. for 22 hours with 50% compression strain, then released and cooled in room temperature for 30 min, then measure the residual strain. The 3D loop article of the present disclosure has a compression residual strain at 70° C. of no greater than 25%, or no greater than 24%, or no greater than 22%, or no greater than 20%, or no greater than 18%, or no greater than 15%, or no greater than 12%, or preferably no greater than 10%.

The 3D loop article of the present disclosure has an apparent density of 40-90 g/cm³, or preferably 50-80 g/cm³, or more preferably 60-70 g/cm³, or even more preferably 65-70 g/cm³.

The 3D loop article can be cushions for seats, mattress, or pillows.

### EXAMPLES

Some embodiments of the invention will now be described in the following Examples, wherein all parts and percentages are by weight unless otherwise specified.

### 1. Materials

The information of the raw materials used in the examples is listed in the following Table 1:

TABLE 1
Material list

| | Vendor | density* | MI** | Type |
|---|---|---|---|---|
| ENGAGE ™ 8402 | DOW | 0.902 | 30 | ethylene/octene |
| | | | | copolymer |
| ENGAGE ™ 8401 | DOW | 0.885 | 30 | ethylene/octene |
| | | | | copolymer |
| ENGAGE ™ 8450 | DOW | 0.902 | 3 | ethylene/octene |
| | | | | copolymer |
| Elite ™ 5815 | DOW | 0.910 | 15 | LLDPE |
| ENGAGE ™ 8480 | DOW | 0.902 | 1 | ethylene/octene |
| | | | | copolymer |
| ENGAGE ™ 8200 | DOW | 0.870 | 5 | ethylene/octene |
| | | | | copolymer |
| EXCEED ™ 3518CB | ExxonMobil | 0.918 | 3.5 | LLDPE |
| HDPE HMA 016 | ExxonMobil | 0.956 | 20 | HDPE |

*unit: g/cm³;
**unit: g/10 min; 190° C. 2.16 kg

### 2. Examples

### Inventive Example A-1

A polyethylene-based thermoplastic elastomer was composited with ENGAGE™ 8401/EXCEED™ 3518CB 60/40 wt %/wt %. The density of the elastomer was 0.901 g/cm³. The melting point of the elastomer was 112° C. The MI of the elastomer was 10 g/10 min (190° C., 2.16 kg). The flexural modulus of the elastomer was 62 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The 3D loop sample had a good morphology for 3DL pad application.

### Inventive Example A-2

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The 3D loop sample had a good morphology for 3DL pad application.

### Inventive Example A-3

A polyethylene-based thermoplastic elastomer was composited with ELITE™ 5815. The density of the elastomer was 0.910 g/cm³. The melting point of the elastomer was 123° C. The MI of the elastomer was 15 g/10 min (190° C., 2.16 kg). The flexural modulus of the elastomer was 94 MPa. A 3D loop sample was produced on 3D loop production line (DIDA-1500) made by DIDA machinery company as follows: the above elastomer was fed into the single extruder to turn into the molten and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 65 g/cm³. The 3D loop sample had a good morphology for 3DL pad application.

### Comparative Example A-1

A polyethylene-based thermoplastic elastomer was composited with ENGAGE™ 8480. The density of the elastomer was 0.902 g/cm³. The melting point of the elastomer was 100° C. The MI of the elastomer was 1 g/10 min (190° C., 2.16 kg). The flexural modulus of the elastomer was 83 MPa. A sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a sample which had poor processability, as indicated by no curling of the fiber strands to form a 3D loop structure.

### Comparative Example A-2

A polyethylene-based thermoplastic elastomer was composited with ENGAGE™ 8402. The density of the elastomer was 0.902 g/cm³. The melting point of the elastomer was 98° C. The MI of the elastomer was 30 g/10 min (190° C., 2.16 kg). The flexural modulus of the elastomer was 72 MPa. A sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a sample, which collapsed during production since MI was too high.

### Comparative Example A-3

A polyethylene-based thermoplastic elastomer was composited with HDPE HMA 016. The density of the elastomer was 0.956 g/cm³. The melting point of the elastomer was 133° C. The MI of the elastomer was 20 g/10 min (190° C., 2.16 kg). The flexural modulus of the elastomer was 970 MPa. The elastomer is too rigid for seat cushion application.

### Comparative Example A-4

A polyethylene-based thermoplastic elastomer was composited with ENGAGE™ 8200. The density of the elastomer was 0.870 g/cm³. The melting point of the elastomer was 60° C. The MI of the elastomer was 5 g/10 min (190° C., 2.16 kg). The flexural modulus of the elastomer was 10 MPa. The elastomer was too soft for seat cushion application.

TABLE 2

| | | | | FLEXURAL | 3DL PAD |
|---|---|---|---|---|---|
| | COMPOSITION | DENSITY* | MI** | MODULUS*** | EVALUATION |
| INVENTIVE | ENGAGE ™ 8401/ | 0.901 | 10 | 62 | Good |
| EXAMPLE A-1 | EXCEED ™ 3518CB | | | | |
| | 60/40 wt %/wt % | | | | |
| INVENTIVE | ENGAGE ™ 8402/ | 0.902 | 12 | 65 | Good |
| EXAMPLE A-2 | ENGAGE ™ 8450 | | | | |
| | 60/40 wt %/wt % | | | | |
| INVENTIVE | ELITE ™ 5815 | 0.910 | 15 | 94 | Good |
| EXAMPLE A-3 | | | | | |
| COMPARATIVE | ENGAGE ™ 8480 | 0.902 | 1 | 83 | Poor |
| EXAMPLE A-1 | | | | | processability |
| | | | | | (No fiber curling) |
| COMPARATIVE | ENGAGE ™ 8402 | 0.902 | 30 | 72 | Poor |
| EXAMPLE A-2 | | | | | processability |
| | | | | | (Collapse) |
| COMPARATIVE | HMA 016 | 0.956 | 20 | 970 | Too rigid |
| EXAMPLE A-3 | | | | | |
| COMPARATIVE | ENGAGE ™ 8200 | 0.870 | 5 | 10 | Too soft |
| EXAMPLE A-4 | | | | | |

*unit: g/cm³;
**unit: g/10 min; 190° C. 2.16 kg;
***MPa

In summary, for vehicle seat application, the flexural modulus of the material composition should range from 20˜120 MPa to ensure comfortable hardness range of the 3DL pad. Correspondingly, the density should range from 0.880˜0.920 g/cm³; the MI range should range from 3˜20 g/10 min (190° C., 2.16 kg) since 3D Loop pad structure made of high MI resins will collapse, and 3DL pad structure made of low MI resins will be difficult to achieve fiber curling during production.

### Inventive Example B-1

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company. The above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 80° C. for 1 hr in the oven, then taken out from the oven and cooled to room temperature. The 70° C. compression residual strain was 21%, and the low-perfection crystal melting enthalpy was 27.9 J/g.

### Inventive Example B-2

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 80° C. for 3 hr in the oven, then taken out from the oven and cooled to room temperature. The 70° C. compression residual strain was 18%, and the low-perfection crystal melting enthalpy was 27.1 J/g.

### Inventive Example B-3

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 80° C. for 6 hr in the oven, then taken out from the oven and cooled to room temperature. The 70° C. compression residual strain was 15%, and the low-perfection crystal melting enthalpy was 25 J/g.

### Inventive Example B-4

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 80° C. for 22 hr in the oven, then taken out from the oven and cooled to room temperature. The 70° C. compression residual strain was 13%, and the low-perfection crystal melting enthalpy was 21.1 J/g.

### Inventive Example B-5

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 90° C. for 6 hr in the oven, then taken out from the oven and cooled to room temperature. The 70° C. compression residual strain was 21%, and the low-perfection crystal melting enthalpy was 28.5 J/g.

### Inventive Example B-6

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 90° C. for 22 hr in the oven, then taken out from the oven and cooled to room temperature. The 70° C. compression residual strain was 18%, and the low-perfection crystal melting enthalpy was 28.9 J/g.

### Inventive Example B-7

A polyethylene-based thermoplastic elastomer was composited with ELITE™ 5815. The density of the elastomer was 0.910 g/cm³. The melting point of the elastomer was 123° C. The MI of the elastomer was 15 g/10 min (190° C., 2.16 kg). The flexural modulus of the elastomer was 94 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 65 g/cm³. The obtained 3D loop sample was heated to 80° C. for 22 hr in the oven, then taken out from the oven and cooled to room temperature. The 70° C. compression residual strain was 13.5%, and the low-perfection crystal melting enthalpy was 21.6 J/g.

### Inventive Example B-8

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 80° C. for 24 hr in the oven, then taken out from the oven and cooled to room temperature. The 70° C. compression residual strain was 10%, and the low-perfection crystal melting enthalpy was 21.1 J/g.

### Inventive Example B-9

A polyethylene-based thermoplastic elastomer was composited with ENGAGE™ 8401/EXCEED™ 3518CB 60/40 wt %/wt %. The density of the elastomer was 0.901 g/cm³. The melting point of the elastomer was 112° C. The MI of the elastomer was 10 g/10 min (190° C., 2.16 kg). The flexural modulus of the elastomer was 62 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 80° C. for 22 hr in the oven, then taken out from the oven and cooled to room temperature. The 70° C. compression residual strain was 12%, and the low-perfection crystal melting enthalpy was 20.1 J/g.

### Inventive Example B-10

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 80 g/cm³. The obtained 3D loop sample was heated to 80° C. for 24 hr in the oven, then taken out from the oven and cooled to room temperature. The 70° C. compression residual strain was 11%, and the low-perfection crystal melting enthalpy was 21.6 J/g.

### Inventive Example B-11

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 30 mm, and an apparent density of 50 g/cm³. The obtained 3D loop sample was heated to 80° C. for 22 hr in the oven, then taken out from the oven and cooled to room temperature. The 70° C. compression residual strain was 15%, and the low-perfection crystal melting enthalpy was 24.5 J/g.

### Comparative Example B-1

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 90° C. for 1 hr in the oven, then taken out from the oven and cooled to room temperature. The 70° C. compression residual strain was 28%, and the low-perfection crystal melting enthalpy was 33.3 J/g.

### Comparative Example B-2

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. The obtained 3D loop sample was heated to 90° C. for 3 hr in the oven, then taken out from the oven and cooled to room temperature. The 70° C. compression residual strain was 28%, and the low-perfection crystal melting enthalpy was 33.1 J/g.

### Comparative Example B-3

A polyethylene-based thermoplastic elastomer was composited with ELITE™ 5815. The density of the elastomer was 0.910 g/cm³. The melting point of the elastomer was 123° C. The MI of the elastomer was 15 g/10 min (190° C., 2.16 kg). The flexural modulus of the elastomer was 94 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 65 g/cm³. No heat treatment was done to the sample. The 70° C. compression residual strain was 34%, and the low-perfection crystal melting enthalpy was 32.5 J/g.

### Comparative Example B-4

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 50 mm, and an apparent density of 70 g/cm³. No heat treatment was done to the sample. The 70° C. compression residual strain was 47%, and the low-perfection crystal melting enthalpy was 32.7 J/g.

### Comparative Example B-5

A polyethylene-based thermoplastic elastomer was composited with ENGAGE™ 8402/ENGAGE™ 8450 60/40 wt %/wt %. The density of the elastomer was 0.902 g/cm³. The melting point of the elastomer was 97° C. The MI of the elastomer was 12 g/10 min (190° C., 2.16 kg). The flexural modulus of the elastomer was 65 MPa. A 3D loop sample was produced on 3D loop production line (DIDA-1500) made by DIDA machinery company as follows: the above elastomer was fed into the single extruder to turn into the molten state and went through the T-shape die installed with round-hole array to produce a fiber melt. The hole diameter was 0.8 mm and distance between holes around 10 mm, the array length was around 400 mm and array width around 50 mm. The fiber melt was dropped to cooling water (around 30° C.) and then pulled by the conveyer belt system with controlled speed around 0.5 meters/min to obtain a 3D loop sample. Then the 3D loop sample was cut into designed size for testing (400 mm*400 mm*50 mm). The obtained 3D loop sample had a fiber diameter around 0.65 mm, a thickness of 30 mm, and an apparent density of 50 g/cm³. No heat treatment was done to the sample. The 70° C. compression residual strain was 5000, and the low-perfection crystal melting enthalpy was 33.2 J/g.

TABLE 3

| | | | | Heat | |
|---|---|---|---|---|---|
| | | Compression | Low-perfection | treatment | Heat |
| | | residual strain | crystal melting | temperature | treatment |
| | Composition | @ 70° C.(%) | enthalpy (J/g)* | (° C.) | time (h) |
| Inventive | ENGAGE ™ 8402/ | 21 | 27.9 | 80 | 1 |
| example B-1 | ENGAGE ™ 8450 | | | | |
| | 60/40 | | | | |
| Inventive | ENGAGE ™ 8402/ | 18 | 27.1 | 80 | 3 |
| example B-2 | ENGAGE ™ 8450 | | | | |
| | 60/40 | | | | |
| Inventive | ENGAGE ™ 8402/ | 15 | 25 | 80 | 6 |
| example B-3 | ENGAGE ™ 8450 | | | | |
| | 60/40 | | | | |
| Inventive | ENGAGE ™ 8402/ | 13 | 21.1 | 80 | 22 |
| example B-4 | ENGAGE ™ 8450 | | | | |
| | 60/40 | | | | |
| Inventive | ENGAGE ™ 8402/ | 21 | 28.5 | 90 | 6 |
| example B-5 | ENGAGE ™ 8450 | | | | |
| | 60/40 | | | | |
| Inventive | ENGAGE ™ 8402/ | 18 | 28.9 | 90 | 22 |
| example B-6 | ENGAGE ™ 8450 | | | | |
| | 60/40 | | | | |
| Inventive | ELITE ™ 5815 | 13.5 | 21.6 | 80 | 22 |
| example B-7 | | | | | |
| Inventive | ENGAGE ™ 8402/ | 10 | 21.1 | 80 | 24 |
| example B-8 | ENGAGE ™ 8450 | | | | |
| | 60/40 | | | | |
| Inventive | ENGAGE ™ 8401/ | 12 | 20.1 | 80 | 22 |
| example B-9 | EXCEED- ™ | | | | |
| | 3518CB 60/40 | | | | |
| Inventive | ENGAGE ™ 8402/ | 11 | 21.6 | 80 | 24 |
| example B-10 | ENGAGE ™ 8450 | | | | |
| | 60/40 | | | | |
| Inventive | ENGAGE ™ 8402/ | 15 | 24.5 | 80 | 22 |
| example B-11 | ENGAGE ™ 8450 | | | | |
| | 60/40 | | | | |
| Comparative | ENGAGE ™ 8402/ | 28 | 33.3 | 90 | 1 |
| example B-1 | ENGAGE ™ 8450 | | | | |
| | 60/40 | | | | |
| Comparative | ENGAGE ™ 8402/ | 28 | 33.1 | 90 | 3 |
| example B-2 | ENGAGE ™ 8450 | | | | |
| | 60/40 | | | | |

| | | | | |
|---|---|---|---|---|
| Comparative | ELITE ™ 5815 | 34 | 32.5 | No annealing treatment |
| example B-3 | | | | |
| Comparative | ENGAGE ™ 8402/ | 47 | 32.7 | No annealing treatment |
| example B-4 | ENGAGE ™ 8450 | | | |
| | 60/40 | | | |
| Comparative | ENGAGE ™ 8402/ | 50 | 33.2 | No annealing treatment |
| example B-5 | ENGAGE ™ 8450 | | | |
| | 60/40 | | | |

*The standard deviation is around 0.5 J/g.

### 3. Testing

Flexural modulus was measured in Instron 5566 in accordance with ASTM D790 at 1.36 mm/min.

Melt index (MI) was tested on a Tinius Olsen MP600 in accordance with ASTM D1238 (2.16 kg, 190° C. test condition).

DSC was tested on a DSC-Q2000 according to the following method:

### Method

1: Equilibrate at 0° C.
2: Data storage: On
3: Ramp 10° C./min to 200° C.
4: Isothermal for 3 min
5: Mark end of cycle 1
6: Ramp −10° C./min to 0° C.
7: Isothermal for 3 min
8: Mark end of cycle 2
9: Ramp 10° C./min to 200° C.
10: Mark end of cycle 3
11: End of method

### Compression Residual Strain:

The compression set of the 3D loop sample was measured according to ASTM D3574-2017. The specimen was a 3D loop pad of 20 cm by 20 cm square shape, with uniform thickness around 5 cm. After compression at 50% strain using a compression fixture for 22 hours at 70° C., the compression was removed, and the 3D loop specimen was allowed to recover for 30 min at room temperature. The final specimen thickness was measured, and the compression set was calculated using the following equation.

$$Compression residual strain ( \% ) = [ ( {T}_{o} - {T}_{f} ) / {T}_{o} ] \times 100$$

where Tₒ is the original specimen thickness, and T_{f} is the final specimen thickness.

### Low-perfection Crystal Melting Enthalpy Calculation

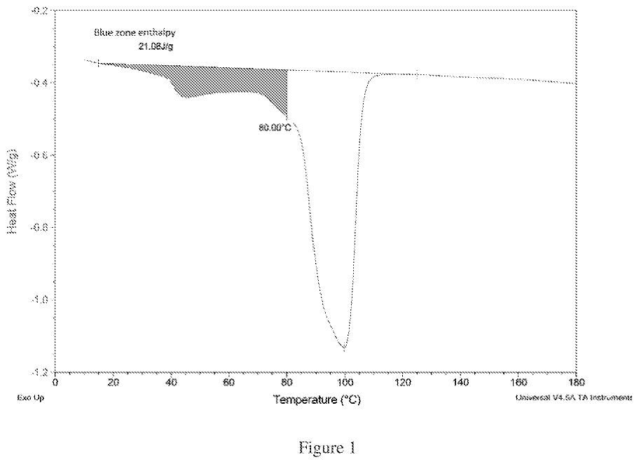

FIG. 1 shows the 1st-heat melting DSC curve and low-perfection crystal melting enthalpy of 3D loop sample of inventive example B-8. The shaded region corresponds to the melting of the low-perfection crystals (temperature range: 15-80° C.). The low-perfection crystal melting enthalpy can be calculated by integrating the area between the melting curve and baseline from 15-80° C. as illustrated in the figure. 16 samples with different low-perfection crystal melting enthalpies and corresponding 3D Loop sample compression residual strain performance at 70° C. are reported in Table 3.

1. A 3D loop article made of a material comprising polyethylene, ethylene/α-olefin copolymer, or a blend of polyethylene and ethylene/α-olefin copolymer, wherein the material has a low-perfection crystal melting enthalpy, calculated within a temperature range of 15-80° C., of less than or equal to 30 J/g.

2. The 3D loop article of claim 1, wherein the ethylene/α-olefin is selected from ethylene/α-olefin random copolymer, ethylene/α-olefin multi-block interpolymer, or a mixture thereof.

3. The 3D loop article of claim 1, wherein the material has a low-perfection crystal melting enthalpy, calculated within a temperature range of 15-80° C., of less than or equal to 29 J/g.

4. The 3D loop article of claim 1, wherein the material has a low-perfection crystal melting enthalpy, calculated within a temperature range of 15-80° C., of less than or equal to 25 J/g.

5. The 3D loop article of claim 1, wherein the material has a MI from about 3 g/10 min to about 20 g/10 min.

6. The 3D loop article of claim 1, wherein the material has a density of between about 0.880 g/cm³ and about 0.920 g/cm³.

7. The 3D loop article of claim 1, wherein the 3D loop article has a compression residual strain at 70° C. of no greater than 25%.

8. The 3D loop article of claim 1, wherein the 3D loop article has a compression residual strain at 70° C. of no greater than 20%.

9. The 3D loop article of claim 1, wherein the material has a low-perfection crystal melting enthalpy, calculated within a temperature range of 15-80° C., of less than or equal to 21 J/g.

10. The 3D loop article of claim 1, wherein the 3D loop article are cushions for seats, mattress, or pillows.

11. A method of producing the 3D loop article of claim 1, comprising:
extruding the material comprising polyethylene, ethylene/α-olefin copolymer, or a blend of polyethylene and ethylene/α-olefin copolymer; and
performing a heat treatment at 70 to 90° C. for 0.5 hours to 5 days;
wherein the material after heat treatment has a low-perfection crystal melting enthalpy, calculated within a temperature range of 15-80° C., of less than or equal to 30 J/g.

12. A 3D loop article made by the process of claim 11.
